(19) United States
(12) Patent Application Publication
(10) Pub. No.: US 2012/0001051 A1
(43) Pub. Date: Jan. 5, 2012

(54) REBOUNDING POST MOUNTING SYSTEM

(76) Inventor: Mark N. Williams, Lupton, MI (US)

(21) Appl. No.: 13/173,585

(22) Filed: Jun. 30, 2011

Related U.S. Application Data
(60) Provisional application No. 61/360,530, filed on Jul. 1, 2010.

(51) Int. Cl. F16M 11/24

(52) U.S. Cl. 248/519

(57) ABSTRACT

A rebounding post mounting system including at least two tube sections with one of the tube sections fixed in position. The at least two tube sections are linked by at least one spring. A tube section not fixed in position deflects relative to the fixed tube section upon an impact and returns to a starting position following the impact.

### REFERENCE TO RELATED APPLICATIONS

This application claims priority to U.S. provisional patent application No. 61/360,530, which was filed Jul. 1, 2010 and is incorporated herein by reference in its entirety.

### FIELD OF THE INVENTION

The present invention relates to a mounting system for posts that rebounds when impacted and more particularly to a spring loaded mounting system designed for mounting of mailbox posts.

### BACKGROUND OF THE INVENTION

Mailbox posts are used at residences and businesses for positioning of mail boxes to receive mail delivery. These posts commonly are rigidly mounted in a hole dug at the correct location and then filled with soil or secured in place by concrete or a similar product. This conventional installation method can cause damage to vehicles or persons if struck when a vehicle leaves the road. Furthermore, when the post or mailbox is struck, particularly by snow moved by a snow plow in colder regions, posts are often broken or damaged and require maintenance by the home owner or business owner. In addition, in cold climates, home owners and business owners place protective fixtures in front of their mailboxes which are unsightly and potentially dangerous in the event that a vehicle leaves the road in icy conditions.

There is therefore a need exists in the art for a post mounting system that can absorb an impact and can rebound without damage. Many applications may exist for a rebounding post mounting system such as for signs or other fixtures near a roadway including mailboxes.

### SUMMARY OF THE INVENTION

In one aspect there is disclosed a rebounding post mounting system including at least two tube sections with one of the tube sections fixed in position. The at least two tube sections are linked by at least one spring. A tube section not fixed in position deflects relative to the fixed tube section upon an impact and returns to a starting position following the impact.

In another aspect, the rebounding post mounting system may include at least two tube sections with one of the tube sections fixed in position. At least two support plates are attached to the first and second tube sections. At least two mounting plates are attached to the first and second tube sections. At least one spring is attached at opposing ends to the at least two mounting plates. A tube section not fixed in position deflects relative to the fixed tube section upon an impact and returns to a starting position following the impact.

In a further aspect, the rebounding post mounting system may include at least two tube sections with one of the tube sections fixed in position. At least two support plates are attached to the first and second tube sections. At least two mounting plates are attached to the first and second tube sections. At least one spring is attached at opposing ends to the at least two mounting plates. Ac entering device is attached on one of the first or second support plates aligning the first and second tube sections. A tube section not fixed in position deflects relative to the fixed tube section upon an impact and returns to a starting position following the impact.

### BRIEF DESCRIPTION OF THE DRAWINGS

FIG. 1 is an exploded perspective view of one embodiment of a rebounding post mounting system;

FIG. 2 is a perspective view of one embodiment of a rebounding post mounting system.

FIG. 3 is a section view from the side of one embodiment of a rebounding post mounting system;

FIG. 4 is a perspective view of one embodiment of a rebounding post mounting system;

FIG. 5 is an exploded perspective view of a rebounding post system having a spring attached using a clamping type device;

FIG. 6 is a sectional view of a rebounding post system having a spring attached using a clamping type device;

FIG. 7 is an exploded perspective view of a rebounding post system having multiple springs;

FIG. 8 is a sectional view of a rebounding post system having multiple springs;

FIG. 9 is an exploded perspective view of one section of a rebounding post system having multiple tube sections;

FIG. 10 is a perspective view of a rebounding post system having multiple tube sections.

### DETAILED DESCRIPTION OF THE PREFERRED EMBODIMENTS

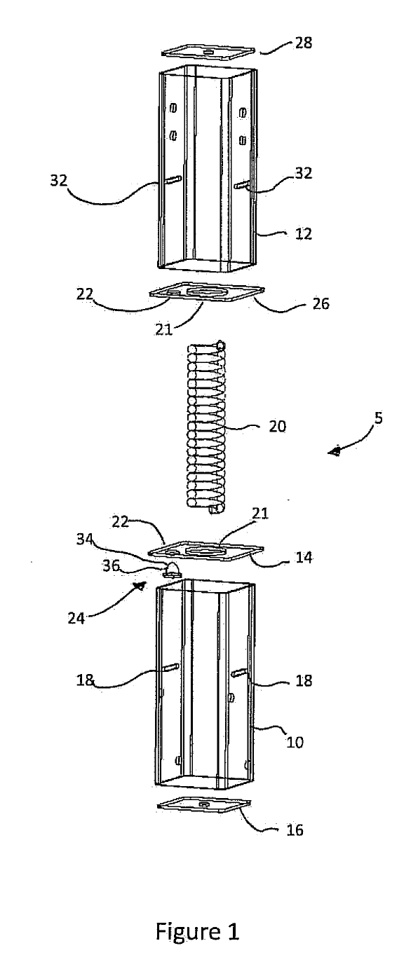

Referring to FIG. 1, there is shown one embodiment of a rebounding post mounting system 5. The rebounding post mounting system 5 may include a first tube section 10 and second tube section 12.

The first tube section 10 may include a first support plate 14 and a spring mounting plate 16. The first tube section 10 may include weld slots 18 for anchoring the first spring mounting plate 16.

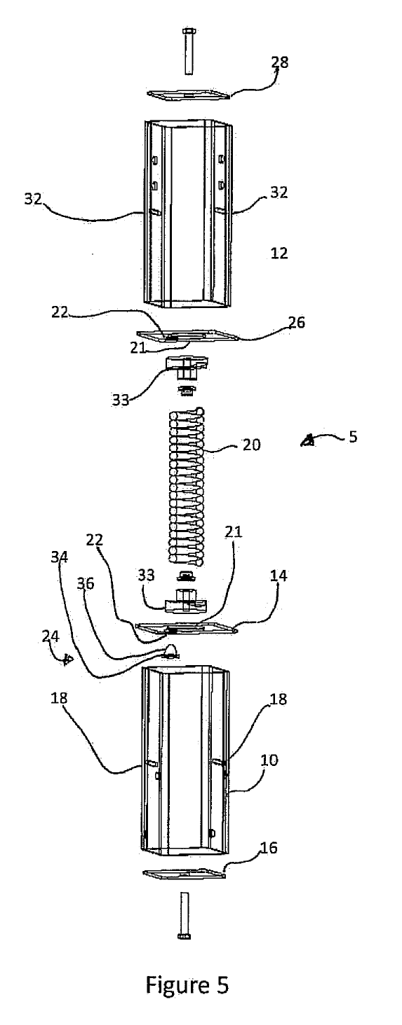

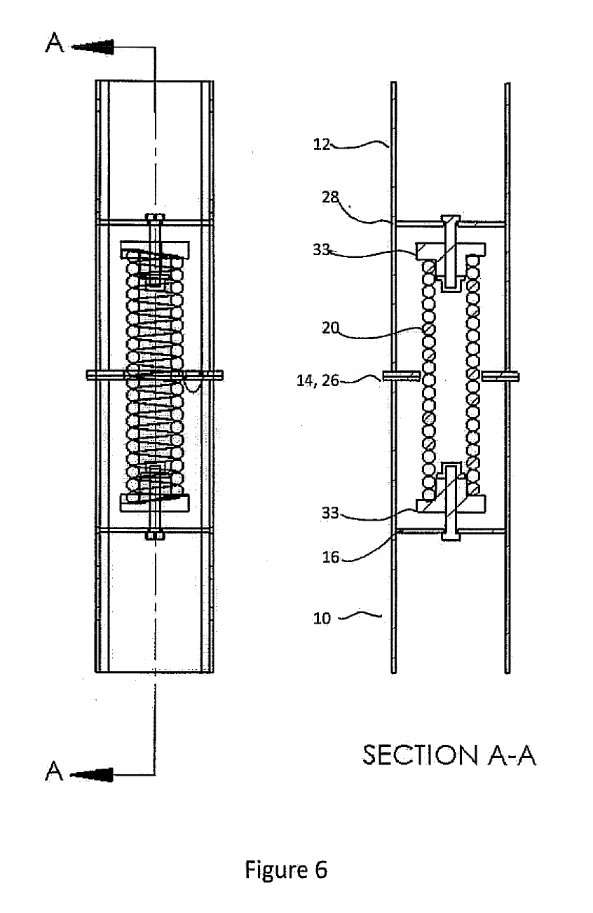

The spring mounting plate 16 may be secured to one end of a spring 20 and attached or welded in place inside the first tube section 10 utilizing the weld slots 18. In one aspect, the spring 20 may be welded to the spring mounting plate 16. In an alternative embodiment, the spring 20 may be secured to the mounting plate 16 without a weld. As shown in FIGS. 5, 6 an end of the spring may be retained by a cap 33 for attachment to each end of the spring. The cap 33 is secured in place by a nut 34 to allow for extension of the spring during installation of the bolts 35 to pretension the spring for correct operation. However, those skilled in the art recognize that a variety of designs may be used to secure the spring 20 to the spring mounting plate 20 without welding.

The first support plate 14 may be attached or welded to an end of the first tube section 10. Those skilled in the art recognize that a variety of fastening methods may be used to secure the first support plate 14 to the first tube section 10. The first support plate 14 may include an opening or clearance hole 21 for the spring 20 to pass through. Additionally, the support plate 14 may include a centering hole 22 to accept a centering device 24, as will be discussed in more detail below.

Referring to FIG. 1, a rebounding post mounting system 5 may include a second tube section 12, a centering device 24, a second support plate 26, and a second spring mounting plate 28. The second spring mounting plate 28 may be secured to an end of the spring 20 opposite the first spring mounting plate 16. In one aspect, the second spring mounting plate 28 may be welded to the end 30 of the spring 20. However, as described above with respect to the first mounting plate, the spring 20 may be attached to the second spring mounting plate 28 without a weld.

The second spring mounting plate 28 may be positioned such that the spring 20 is stretched to provide some tension. The second spring mounting plate 28 may then be attached within the second tube section 12 such as through weld slots 32.

The second support plate 26 may include a centering device 24. In one aspect, the centering device 24 may include a nut 34 having a domed top surface 36 which is attached on the second support plate 26 prior to attachment to the first tube section 10. The domed surface 36 of the nut 34 may protrude through the second support plate 26 and align with the centering hole 22 in the first support plate 14. It should be realized that a variety of structures may be used to align the first and second tube sections 10, 12 after the spring 20 is stretched following an impact.

In one aspect, the spring 20 retains the first and second tube sections 10, 12 together after both the first and second spring mounting plate 16, 28 are attached in a desired position. The spring 20 as shown in the figures may be an extension spring designed for the required force and travel for the rebounding post mounting system 5. The spring 20 provides tension for stability of the post in its static condition and yet has enough travel to allow the post and second section to deflect as necessary during an impact.

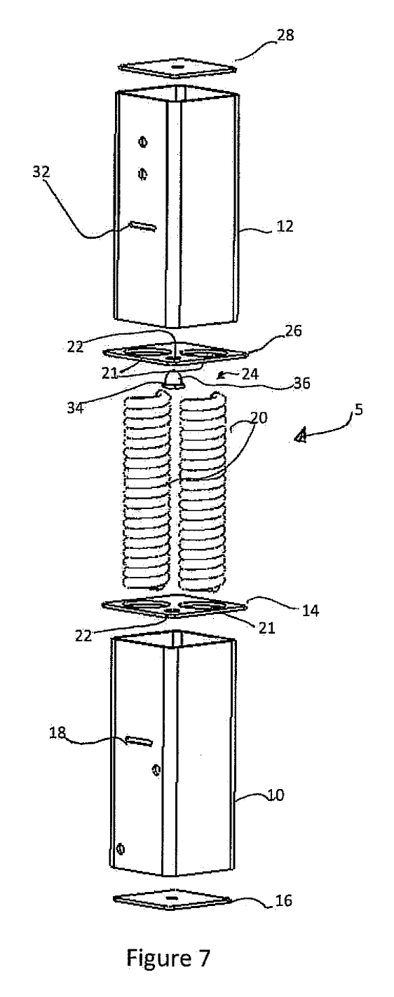

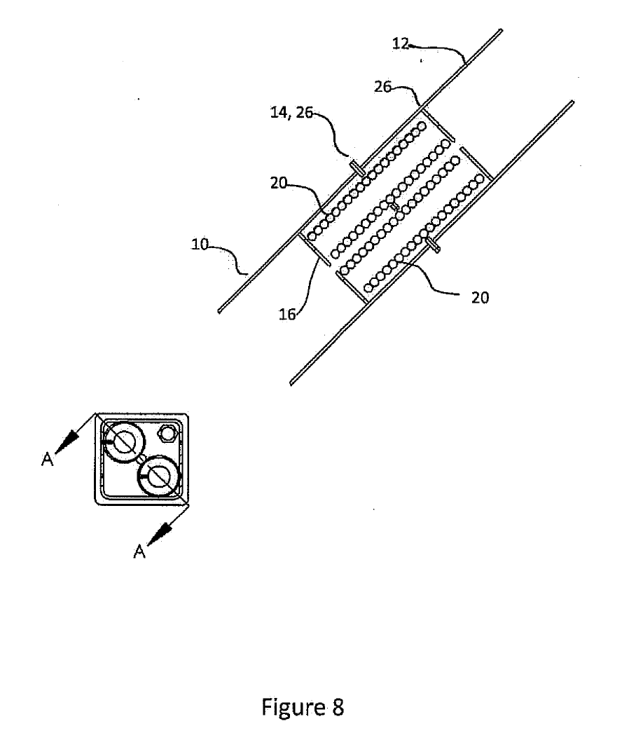

In one aspect, a post mounting system 5 may include a spring 20 having a free length of approximately seven and one half inches and it is one and three-fourths inches in outside diameter. The spring 20 may be stretched one half inch when installed. Those skilled in the art recognize that many different spring designs may accomplish the design intent and that different applications for the rebounding post mounting system may require different spring specifications. Additionally, as shown in FIGS. 7, 8 multiple springs 20 may be attached to the mounting plates 16, 28 to provide a required reaction force or to allow movement of the first and second tube sections 10, 12 in a desired or specified direction. Additionally, various types of springs including torsion, tension, other flexible members such as bars or other structures formed of plastic or polymeric compositions may be utilized.

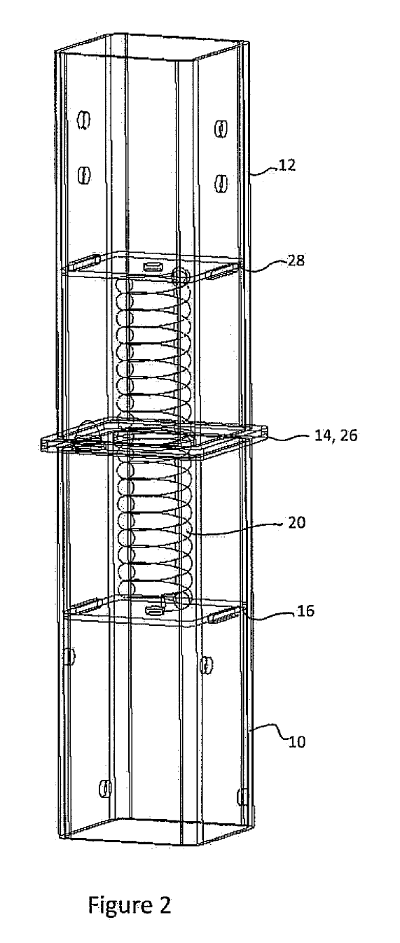

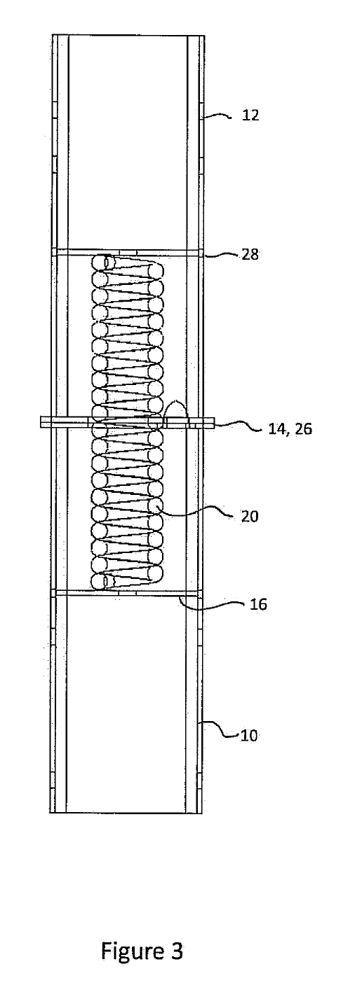

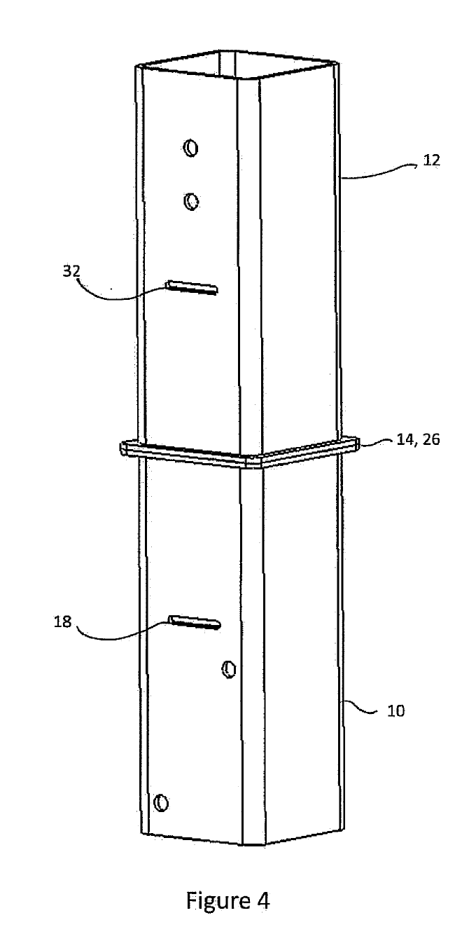

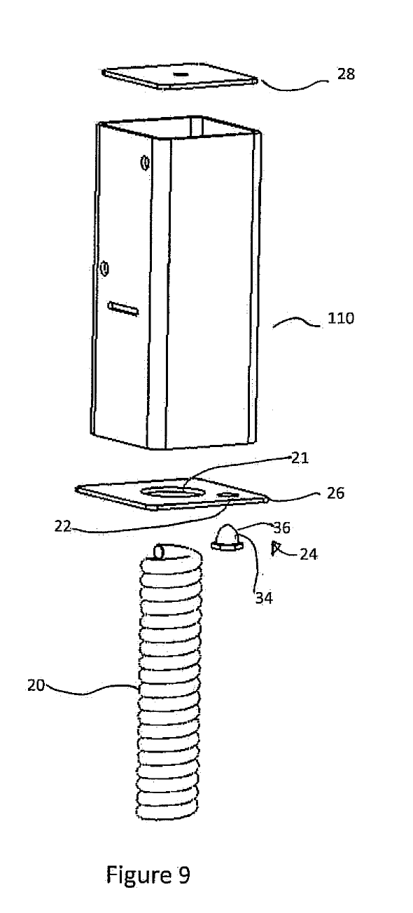

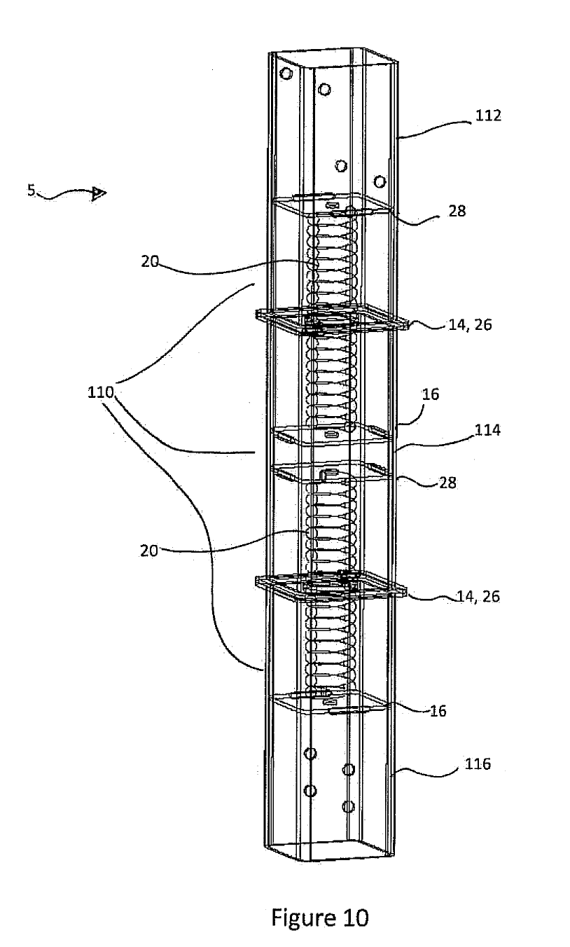

Referring to FIG. 9-10 another alternative embodiment of a post mounting system 5 may include multiple tubular sections 110 that may have a square cross section to allow motion at more than one interface. As illustrated in the Figures, the post mounting system 5 may include multiple sections that may correspond to the previously described first tube section 10 and second tube section 12. In the depicted embodiment, there are shown three tube sections 112, 114, 116 that are joined to provide two articulating joints 120. The depicted embodiment is similar to the previous embodiment of FIGS. 1-5 but also includes connection of the second tube section 114 connected to the third tube section 116 with an additional spring 20 to allow freedom of movement at the joint between the second and third tubular sections 114, 116 when the post is loaded. Various springs 20 may be used at each joint may and may not be of the same design. Additionally, various numbers of sections 110 may be utilized to provide differing numbers of articulating joints 120. For example, four sections 110 may be joined to provide three articulating joints 120. One of skill in the art may be able to accommodate various design considerations using multiple articulation joints 120.

A variety of posts may be used with the rebounding post mounting system 5. In one aspect a standard wooden three and one half inch square post may be utilized. The posts may be positioned within either the first or second tube sections 10, 12. In one aspect the second tube 12 section may include a member attached to the surface. Alternatively, the second tube 12 section may be attached to the surface. Further, the first tube section or moveable section 10 may include a mounting member positioned therein. The mounting member may include a mailbox attached thereon. In one aspect, rebounding post mounting system 5 may also include a decorative sleeve installed over the first tube section 10.

The invention has been described in an illustrative manner. It is to be understood that the terminology, which has been used, is intended to be in the nature of words of description rather than limitation. Many modifications and variations of the invention are possible in light of the above teachings. Therefore, within the scope of the appended claims, the invention may be practiced other than as specifically described.

1. A rebounding post mounting system comprising:
at least two tube sections with one of the tube sections fixed in position;
the at least two tube sections linked by at least one spring wherein a tube section not fixed in position deflects relative to the fixed tube section upon an impact and returns to a starting position following the impact.

2. The rebounding post mounting system of claim 1 including first and second tube sections.

3. The rebounding post mounting system of claim 2 including first and second support plates attached to the first and second tube sections.

4. The rebounding post mounting system of claim 3 including a centering device attached on one of the first or second support plates aligning the first and second tube sections following the impact.

5. The rebounding post mounting system of claim 1 wherein the at least one spring is an extension spring.

6. The rebounding post mounting system of claim 1 wherein the at least one spring includes a plurality of springs.

7. The rebounding post mounting system of claim 5 wherein the spring is approximately seven and one half inches long and one and three fourths inches in diameter;

8. The rebounding post mounting system of claim 7, wherein the spring is stretched approximately one half inch when the mounting system is assembled.

9. The rebounding post mounting system of claim 1 including first and second mounting plates attached to the first and second tube sections.

10. The rebounding post mounting system of claim 9 wherein the at least one spring is attached at opposing ends to the first and second mounting plates.

11. The rebounding post mounting system of claim 9 wherein the spring is attached to the first and second mounting plates using a clamp device.

12. The rebounding post mounting system of claim 9 wherein the spring is attached to the first and second mounting plates by a weld.

13. The rebounding post mounting system of claim 1 including a plurality of tube sections joined to each other by at least one spring.

14. The rebounding post mounting system of claim 1 wherein the fixed tube section receives a member attached to a surface.

15. The rebounding post mounting system of claim 1 wherein the moveable tube section receives a mounting member.

16. The rebounding post mounting system of claim 15 wherein the mounting is attached to a mailbox.

17. A rebounding post mounting system comprising:
at least two tube sections with one of the tube sections fixed in position;
at least two support plates attached to the first and second tube sections,
at least two mounting plates attached to the first and second tube sections;
at least one spring attached at opposing ends to the at least two mounting plates;
wherein a tube section not fixed in position deflects relative to the fixed tube section upon an impact and returns to a starting position following the impact.

18. A rebounding post mounting system comprising:
at least two tube sections with one of the tube sections fixed in position;
at least two support plates attached to the first and second tube sections,
at least two mounting plates attached to the first and second tube sections;
at least one spring attached at opposing ends to the at least two mounting plates;
a centering device attached on one of the first or second support plates aligning the first and second tube sections;
wherein a tube section not fixed in position deflects relative to the fixed tube section upon an impact and returns to a starting position following the impact.
